(19) United States
(12) Patent Application Publication
(10) Pub. No.: US 2012/0139285 A1
(43) Pub. Date: Jun. 7, 2012

(54) ROOF APPARATUS FOR CONVERTIBLE CAR

(75) Inventors: Tae Wan Park, Seoul (KR); Yoon Kyoung Han, Hwaseong-si (KR)

(73) Assignee: Hyundai Motor Company, Seoul (KR)

(21) Appl. No.: 13/210,895

(22) Filed: Aug. 16, 2011

(30) Foreign Application Priority Data
Dec. 6, 2010 (KR) 10-2010-0123819

(51) Int. Cl. B60J 7/057

(52) U.S. Cl. 296/108; 296/121

(57) ABSTRACT

A roof apparatus for a convertible car is provided, which includes a front roof and a rear roof which are folded and unfolded by a motor, a support provided at a lower portion of the rear roof for supporting the rear roof; wherein the support including, a base provided at a lower surface of the rear roof in a relatively rotatable manner; an output gear provided on the base that is motor driven; a driving gear engaged with the output gear to rotate on the base, a plurality of links rotatably engaged to the driving gear, and a latch connected to the respective links and rotated by the links on the base so as to be latched to or unlatched from the rear roof. The roofs folded and unfolded by the motor system are able to quickly operate and be accurately controlled. The unfolded roofs are firmly supported by the roof support for supporting the rear roof to increase the overall strength of the roof device.

### CROSS-REFERENCE TO RELATED APPLICATION

This application is based on and claims priority from Korean Patent Application Number 10-2010-0123819 filed Dec. 6, 2010, the entire contents of which application is incorporated herein for all purposes by this reference.

### BACKGROUND OF INVENTION

1. Field of Invention

The present invention relates to a roof apparatus for a convertible car, and more particularly, to a roof apparatus for a convertible car capable of firmly supporting a roof, which is operated by a motor, in an opened state.

2. Description of Related Art

In general, a hardtop of a convertible car includes a front roof and a rear roof, and a center part of the front roof and the rear roof is separated. When the hardtop is opened, a trunk compartment lid is opened, and the front roof and the rear roof are folded from a forward direction to a front direction and then are stored in a trunk compartment. When the hardtop is closed, the trunk compartment lid is reopened, and the front roof and the rear roof are unfolded from the rearward direction to the frontward direction.

Such a retractable roof apparatus is operated by a hydraulic system installed in the trunk compartment.

However, the hydraulic system can obtain a relatively high force, but properties of an operating fluid are varied depending upon a temperature, which changes the performance thereof. In addition, there is a risk of leaking the operating fluid due to a deterioration phenomenon which is caused by, for example, long use. Further, since a response speed is not quick, the control of operation speed is not easy. Also, it is a little difficult to control a plurality of cylinders, which need different force, by using a single hydraulic pump.

Therefore, in view of these drawbacks, the roof of the convertible car is provided with a motor system, instead of the hydraulic system, to solve the drawbacks occurring during the operation.

However, since the motor system does not obtain the strong force enough to firmly support the unfolded roof as compared with the hydraulic system, separate supporting means for firmly supporting the roof is required. The supporting means should be operated in cooperation with the roof of the convertible car, and has to have a mechanism with no drawbacks described above in the hydraulic system during operation.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, various aspects of the present invention has been made to address the above-mentioned problems occurring in the prior art while advantages achieved by the prior art are maintained intact.

Various aspects of the present invention provide for a roof apparatus for a convertible car including a motor system for operating a roof of the convertible car and a support for firmly supporting the unfolded roof, thereby preventing performance from being deteriorated due to variations of operating fluid, and the operating fluid from leaking, and increasing the operation force and the overall strength of the roof apparatus.

In one aspect of the present invention, there is provided a roof apparatus for a convertible car, comprising a front roof and a rear roof which are folded and unfolded by a motor, a support provided at a lower portion of the rear roof for supporting the rear roof, wherein the support including, a base provided at a lower surface of the rear roof in a relatively rotatable manner, an output gear provided on the base and rotated by the motor, a driving gear engaged with the output gear to rotate on the base, a plurality of links rotatably engaged to the driving gear, and a latch connected to the respective links and rotated by the links on the base so as to be latched to or unlatched from the rear roof.

The base may be provided with a stopper having a protruding stopper pin, and the driving gear may be provided with a slot, through which the stopper pin penetrates, formed in a circumferential direction to limit a rotation amount of the driving gear to be rotated.

In addition, it is desirable that the rear roof corresponding to the latch is provided with a striker having a locking pin, and the latch is latched to or unlatched from the locking pin.

With the roof apparatus for the convertible car according to the present invention as described above, the mechanism for operating the roof can be implemented by the motor system by driving the support, which is operated in cooperation with the roof and supports the unfolded roof, using the motor.

Accordingly, the present invention addresses the disadvantages of the hydraulic system in the related art. That is, it is possible to prevent in advance the performance from being deteriorated due to variations in operating fluid according to a temperature and the operating fluid from leaking. Further, operating parts needing a quick operating force and different force can be simultaneously controlled by using a speed increasing ratio or a speed reducing ratio of a gear.

Moreover, according to the present invention, the overall strength of the roof apparatus can be increased by firmly supporting the unfolded roof with the support.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating an exemplary support for a convertible car according to the present invention.

FIG. 2 is a cross-sectional view illustrating an exemplary support according to the present invention.

FIG. 3 is an exploded view illustrating an exemplary support according to the present invention.

FIG. 4 is a view illustrating an opened state of an exemplary support before a rear roof according to the present invention is opened.

FIG. 5 is a view illustrating a closed state of an exemplary support after a rear roof according to the present invention is opened.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

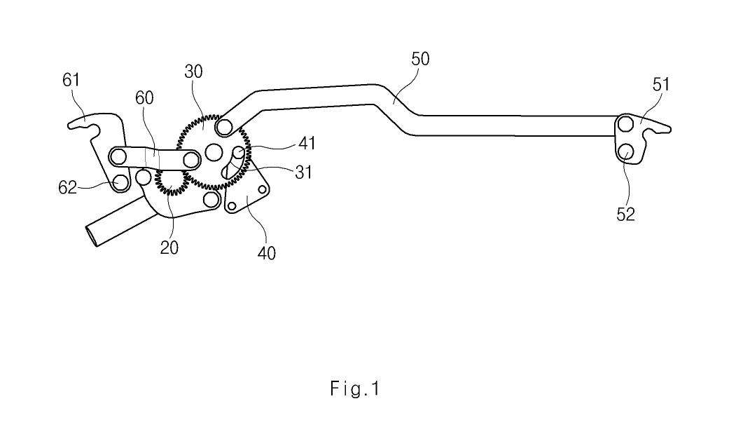

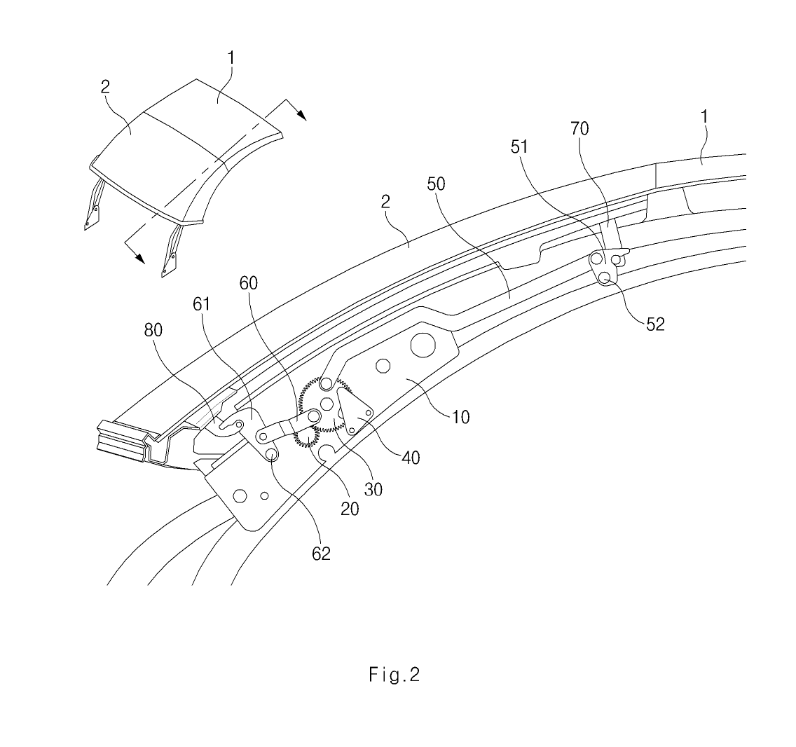

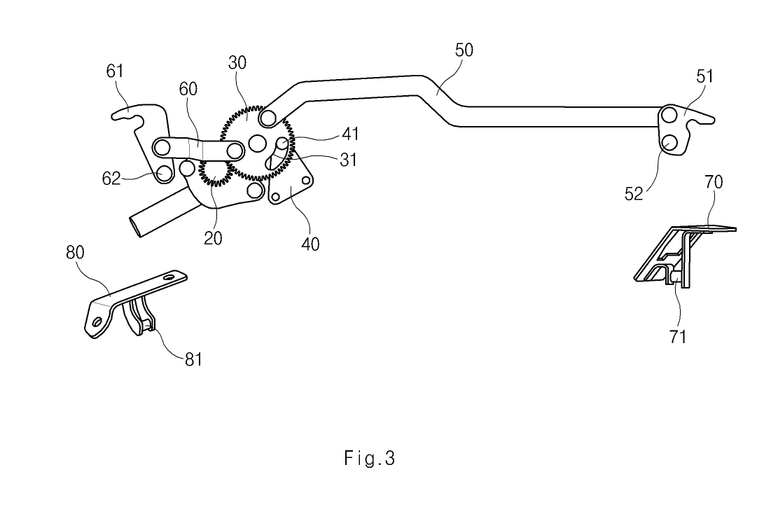

FIGS. 1 to 5 are views illustrating a roof apparatus for a convertible car and a support according to various embodiments of the present invention.

The roof apparatus according to the present invention includes a front roof 1 and a rear roof 2 which are able to be folded and unfolded by a motor system.

The rear roof 2 is provided at a lower portion thereof with the support for firmly supporting the rear roof 2 when the roof is unfolded.

The support includes, as shown in FIGS. 1 to 3, a base 10, an output gear 20, a driving gear 30, a stopper 40, links 50 and 60, latches 51 and 61, and strikers 70 and 80.

The base 10 is installed on a lower surface of the rear roof 2 in such a manner that the base is able to relatively rotate with respect to the rear roof 2. Accordingly, the rear roof 2 can be rotated on the base 10 by the motor system.

The output gear 20 is rotatably installed on the base 10, and is rotated in a forward or reverse direction by a motor which is connected to one side of the output gear.

The driving gear 30 is rotatably installed at one side of the base 10 spaced apart from the output gear 20, and the driving gear 30 is engaged with the output gear 20. The driving gear 30 is provided with a slot 31 in a circumferential direction, through which a stopper pin 41 of the stopper 40 which will be described later penetrates.

The stopper 40 is fixedly installed to the base 10, and is provided at one surface thereof with the stopper pin 41 which penetrates the slot 31 of the driving gear 30. Accordingly, the rotation the driving gear 30 is limited by the stopper pin 41 inserted into the slot 31, and thus the rotation amount of the driving gear 30 is limited by the length of the slot 31.

The link is classified as a front link 50 and a rear link 60 which are rotatably coupled to front and rear sides of the driving gear 30, respectively, and the front link 50 and the rear link 60 are pushed or pulled by the rotation of the driving gear 30.

In addition, the front latch 51 and the rear latch 61 are rotatably connected to the ends of the front link 50 and the rear link 60, respectively, and lower ends of the latches 51 and 61 are rotatably hinged to the base 10. Accordingly, the latches 51 and 61 are rotated around hinge shafts 52 and 62 on the base 10 by the pushing or pulling of the respective links 50 and 60.

The latches 51 and 61 are respectively latched to or unlatched from the front and rear ends of the rear roof 2, and strikers are installed at the front and rear ends of the rear roof 2.

The striker is classified as a front striker 70 installed at the lower front end of the rear roof 2, and a rear striker 80 installed at the lower rear end of the rear roof 2. Each of the strikers 70 and 80 is provided with licking pins 71 and 81, and each of the latches 51 and 61 is latched to or unlatched from the locking pins 71 and 81. In particular, the strikers 70 and 80 are rotated together with the rear roof 2, in the state in which the latches 51 and 61 are unlatched.

The operation of the roof apparatus for the convertible car according to the present invention will now be described.

Since the roof of the convertible car is operated in the same way as that of the related art, the description thereof will be omitted herein. It will be described based on the operation of the support.

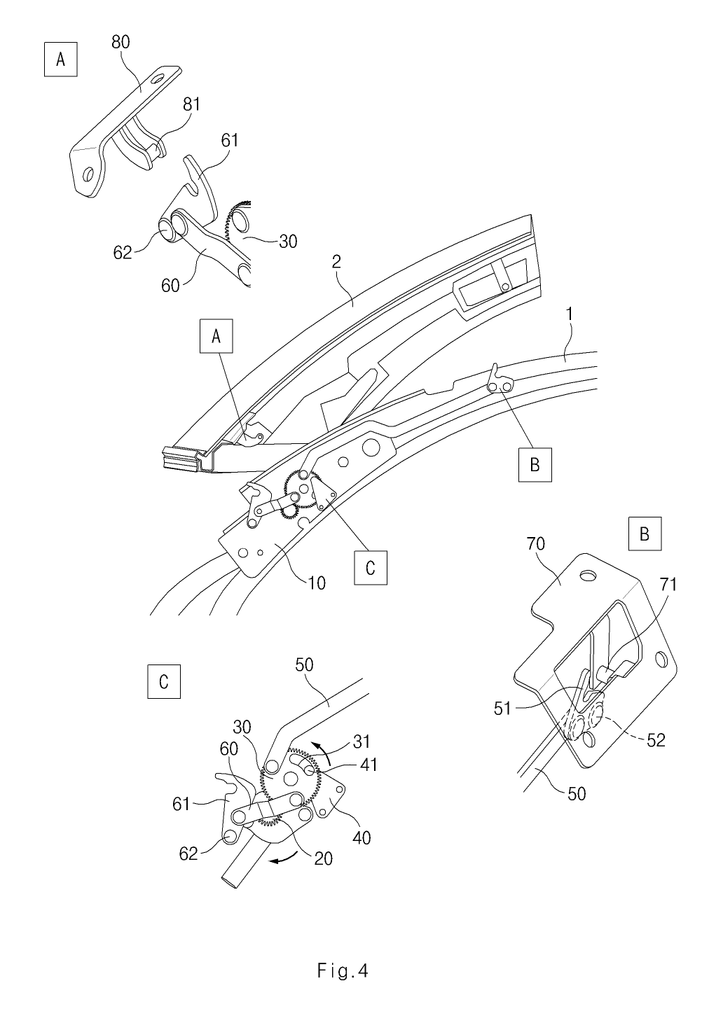

First, as shown in FIG. 4, before the roofs 1 and 2 are opened, the motor of the support are operated to rotate the output gear 20 in a clockwise direction (refer to FIG. 4).

Then, the driving gear 30 engaged with the output gear 20 is rotated in a counterclockwise direction, and the driving gear is continuously rotated until the stopper pin 41 of the stopper 40 comes into contact with the other end of the slot 31.

By the rotation of the driving gear 30 as described above, the front link 50 and the rear link 60 which are rotatably connected to the driving gear 30 are pulled toward the driving gear 30. The latches 51 and 61 rotatably connected to the ends of the links 50 and 60 are respectively rotated around the hinge shafts 52 and 62 of the links 50 and 60 by the links 50 and 60 pulled as described above.

Therefore, each of the latches 51 and 61 rotated as described above is unlatched from the locking pin 71 of the front striker 70 provided at the rear roof 2, and the locking pin 81 of the rear striker 80, so that the rear roof 2 can be folded and inserted into a truck compartment.

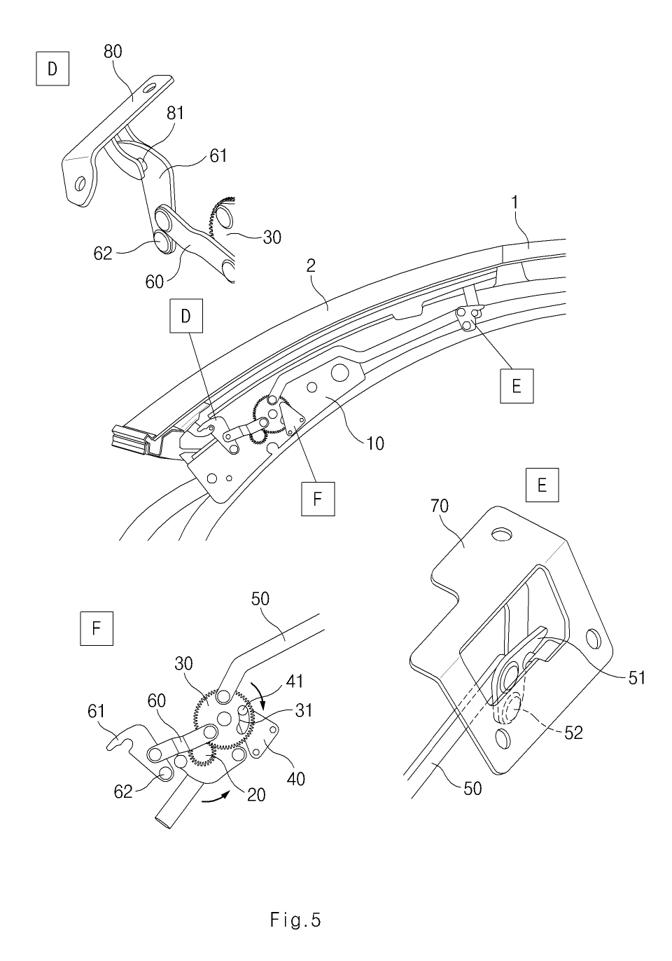

As shown in FIG. 5, after the folded roofs 1 and 2 are unfolded and closed, the motor of the support is reversely operated to rotate the output gear 20 in a counterclockwise direction (refer to FIG. 5).

The driving gear 30 engaged with the output gear 20 is rotated in a clockwise direction until the stopper pin 41 of the stopper 40 comes into contact with one end of the slot 31. The front link 50 and the rear link 60 are moved away from the driving gear 30 by the rotation of the driving gear 30. The latches 51 and 61 are reversely rotated around the hinge shafts 52 and 62 provided at the lower end of the latches 51 and 61 by the pushed links 50 and 60. Thus, the latches 51 and 61 are respectively latched to the locking pin 71 of the front striker 70 of the rear roof 2 and the locking pin 81 of the rear striker 80.

The roofs 1 and 2 folded and unfolded as described above are able to quickly operate and be accurately controlled. The unfolded roofs 1 and 2 are firmly supported by the support for supporting the rear roof 2, as described above, to increase the overall strength of the roof apparatus.

For convenience in explanation and accurate definition in the appended claims, the terms lower, front or rear, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A roof apparatus for a convertible car, comprising:
a front roof and a rear roof which are drivingly folded and unfolded with respect to one another;
a support provided at a lower portion of the rear roof for supporting the rear roof;
wherein the support includes:
a base provided at a lower surface of the rear roof in a relatively rotatable manner;
an output gear provided on the base and rotatingly driven; a driving gear engaged with the output gear to rotate on the base;
a plurality of links rotatably engaged to the driving gear; and
a latch connected to the respective links and rotated by the links on the base so as to be latched to or unlatched from the rear roof.

2. The roof apparatus according to claim 1, wherein the base is provided with a stopper having a protruding stopper pin, and the driving gear is provided with a slot, through which the stopper pin penetrates, formed in a circumferential direction to limit a rotation amount of the driving gear to be rotated.

3. The roof apparatus according to claim 1, wherein the rear roof corresponding to the latch is provided with a striker having a locking pin, and the latch is latched to or unlatched from the locking pin.
